(19) United States
(12) Patent Application Publication
(10) Pub. No.: US 2026/0348307 A1
(43) Pub. Date: Nov. 5, 2026

(54) ADDITIVE LAYER MANUFACTURING EXHAUST MIXERS WITH DAMPING CAVITIES FOR GAS TURBINE ENGINES

(71) Applicants: Rolls-Royce North American Technologies Inc., Indianapolis, IN (US); Rolls-Royce Corporation, Indianapolis, IN (US)

(72) Inventors: Andrew M. Simonich, Indianapolis, IN (US); Michel S. Smallwood, Indianapolis, IN (US); Jordan Thralls, Indianapolis, IN (US)

(21) Appl. No.: 19/195,696

(22) Filed: Apr. 30, 2025

(51) Int. Cl. F01D 25/30; B33Y 10/00; B33Y 80/00; F01D 25/04

(52) U.S. Cl. CPC F01D 25/305; B33Y 10/00; B33Y 80/00; F01D 25/04; F05D 2230/31; F05D 2240/127; F05D 2260/96

(57) ABSTRACT

A gas turbine engine includes an engine core, a fan assembly, and an exhaust mixer formed via additive layer manufacturing and arranged aft of the engine core and fan assembly. The exhaust mixer includes inner lobes and outer lobes, and a damping cavity arranged on or at least partially within the inner and outer lobes. The e damping cavity includes a damping medium arranged therein. The damping cavity can be selectively formed via the additive layer manufacturing so as to selectively effect a parameter of the damping cavity based on a predicted vibratory response of the exhaust mixer that occurs during operation of the engine such that movement of the damping medium within the damping cavity damps vibrations of the exhaust mixer.

### FIELD OF THE DISCLOSURE

The present disclosure relates generally to gas turbine engines, and in particular, to components of gas turbine engines that can be formed via additive layer manufacturing processes.

### BACKGROUND

Gas turbine engines are used to power aircraft, watercraft, power generators, and the like. Gas turbine engines typically include a compressor, a combustor, and a turbine. The compressor compresses air drawn into the engine and delivers high pressure air to the combustor. In the combustor, fuel is mixed with the high-pressure air and is ignited. Products of the combustion reaction in the combustor are directed into the turbine where work is extracted by rows of rotating blades and non-rotating vanes to drive the compressor and, sometimes, an output shaft. Each blade and vane has an airfoil that interacts with gases as they pass through the engine.

Construction and assembly of gas turbine engine components can present many challenges due to the great complexity of the components and the assembly process of these components. Engine components must be manufactured with the utmost precision to ensure the engine is assembled as accurate to design as possible, as well as to ensure smooth and safe operation of the engine.

### SUMMARY

The present disclosure may comprise one or more of the following features and combinations thereof.

According to a first aspect of the present disclosure, a gas turbine engine includes an engine core arranged about a central axis of the gas turbine engine and configured to combust a first portion of air entering the gas turbine engine and exhaust the combusted air aft of the engine core, a fan assembly including an inlet fan forward of the engine core and a bypass duct located aft of the inlet fan and at least partially radially surrounding the engine core. The inlet fan directs the first portion of air into the engine core and a second portion of air into the bypass duct, and an exhaust mixer formed via additive layer manufacturing and arranged aft of the engine core and the bypass duct. The exhaust mixer is configured to mix the second portion of air exiting the bypass duct and the first portion of air exiting the engine core and subsequently exhaust the mixture of the first and second portions of air aft of the engine, the exhaust mixer including an annular wall extending about the central axis and having a plurality of inner lobes that each define a first channel therein that opens radially outwardly and a plurality of outer lobes that each define a second channel therein that opens radially inwardly.

In some embodiments, the exhaust mixer includes at least one damping cavity arranged on or at least partially within the annular wall on an inner lobe or an outer lobe of the plurality of inner and outer lobes, the at least one damping cavity includes a damping medium arranged therein, and the at least one damping cavity is configured to be selectively formed via the additive layer manufacturing so as to selectively effect at least one parameter of the at least one damping cavity based on a predicted vibratory response of the exhaust mixer that occurs during operation of the gas turbine engine such that movement of the damping medium within the at least one damping cavity damps vibrations of the exhaust mixer.

In some embodiments, the at least one parameter of the at least one damping cavity that is selectively effected via the additive layer manufacturing of the at least one damping cavity includes a location of the at least one damping cavity on the inner or outer lobe, a size and/or volume of the at least one damping cavity, an internal surface area of the at least one damping cavity, a density of the at least one damping cavity and/or the damping medium, a packing density of the damping medium, or a density and/or size of particles of the damping medium.

In some embodiments, the plurality of inner and outer lobes each extend toward and terminate at an aft end of the exhaust mixer, and the annular wall alternates between inner and outer lobes about a circumferential extent of the exhaust mixer.

In some embodiments, the at least one damping cavity includes a plurality of damping cavities each formed within opposing side walls of each inner lobe of the plurality of inner lobes.

In some embodiments, the plurality of inner lobes alternate about the circumferential extent of the exhaust mixer between first inner lobes that have a radially inner end located a first distance from the central axis and second inner lobes that have a radially inner end located a second distance from the central axis, the second distance is greater than the first distance.

In some embodiments, the plurality of damping cavities include first damping cavities formed in the first inner lobes and second damping cavities formed in the second inner lobes, and a volume of the first damping cavities is greater than a volume of the second damping cavities.

In some embodiments, the at least one damping cavity includes a plurality of damping cavities each formed within the second channel of the plurality of outer lobes.

In some embodiments, each damping cavity is formed in a radially outer side of the outer lobe, and each damping cavity is defined by a radially outer wall of the outer lobe and a second wall extending between spaced apart locations on the radially outer wall, the second wall being spaced apart from the radially outer wall so as to define the damping cavity therebetween.

In some embodiments, the second wall includes a recessed portion that extends in an axial direction of the exhaust mixer.

In some embodiments, the at least one damping cavity is defined by at least one raised enclosure formed on a radially outer side of one of the plurality of outer lobes.

In some embodiments, the at least one raised enclosure includes a radially outer top wall spaced apart from a radially outer wall of the outer lobe so as to define the damping cavity therebetween.

In some embodiments, the at least one raised enclosure includes a plurality of raised enclosures each defining a damping cavity of the plurality of damping cavities therein, a first group of the plurality of raised enclosures are arranged on the radially outer side of the plurality of outer lobes, and a second group of the plurality of raised enclosures are arranged on the radially outer side of a transition between the plurality of outer lobes and an adjacent inner lobe.

According to a further aspect of the present disclosure, an exhaust mixer for gas turbine engine includes an annular wall that extends about a central axis of the gas turbine engine, the annular wall including a plurality of inner lobes that each define a first channel therein that opens radially outwardly and a plurality of outer lobes that each define a second channel therein that opens radially inwardly, and at least one damping cavity arranged on or at least partially within the annular wall on an inner lobe or an outer lobe of the plurality of inner and outer lobes.

In some embodiments, the at least one damping cavity includes a damping medium arranged therein such that movement of the damping medium within the at least one damping cavity damps vibrations of the exhaust mixer.

In some embodiments, the at least one damping cavity is configured to be selectively formed via the additive layer manufacturing so as to selectively effect at least one parameter of the at least one damping cavity based on a predicted vibratory response of the exhaust mixer during operation of the gas turbine engine such that movement of the damping medium within the at least one damping cavity damps vibrations of the exhaust mixer.

In some embodiments, the at least one parameter of the at least one damping cavity that is selectively effected via the additive layer manufacturing of the at least one damping cavity includes a location of the at least one damping cavity on the inner or outer lobe relative to a forward end of the exhaust mixer, a size and/or volume of the at least one damping cavity, an internal surface area of the at least one damping cavity, a density of the at least one damping cavity and/or the damping medium, a packing density of the damping medium, or a density and/or size of particles of the damping medium.

In some embodiments, the plurality of inner and outer lobes each extend away from an aft end of the exhaust mixer, and the annular wall alternates between inner and outer lobes about a circumferential extent of the exhaust mixer.

In some embodiments, the at least one damping cavity includes a plurality of damping cavities formed in at least one of within opposing side walls of each inner lobe of the plurality of inner lobes or within the second channel of the plurality of outer lobes.

According to a further aspect of the present disclosure, a method includes arranging an engine core about a central axis of a gas turbine engine, the engine core configured to combust a first portion of air entering the gas turbine engine and exhaust the combusted air aft of the engine core, providing a fan assembly including an inlet fan arranged forward of the engine core and a bypass duct located aft of the inlet fan and at least partially radially surrounding the engine core, the inlet fan directs the first portion of air into the engine core and a second portion of air into the bypass duct, and forming an exhaust mixer via additive layer manufacturing and arranging the exhaust mixer aft of the engine core and the bypass duct, the exhaust mixer configured to mix the second portion of air exiting the bypass duct and the first portion of air exiting the engine core and subsequently exhaust the mixture of the first and second portions of air aft of the engine.

In some embodiments, forming the exhaust mixer includes forming an annular wall extending about the central axis, the annular wall having a plurality of inner lobes that each define a first channel therein that opens radially outwardly and a plurality of outer lobes that each define a second channel therein that opens radially inwardly, and forming at least one damping cavity on or at least partially within the annular wall on an inner lobe or an outer lobe of the plurality of inner and outer lobes, the at least one damping cavity is formed to include a damping medium arranged therein such that movement of the damping medium within the at least one damping cavity damps vibrations of the exhaust mixer.

In some embodiments, the method further includes determining a predicted vibratory response of the exhaust mixer that occurs during operation of the gas turbine engine, and selectively forming the at least one damping cavity in order to effect at least one parameter of the at least one damping cavity based on the predicted vibratory response of the exhaust mixer.

In some embodiments, the at least one parameter of the at least one damping cavity that is selectively effected via the additive layer manufacturing of the at least one damping cavity includes a location of the at least one damping cavity on the inner or outer lobe relative to a forward end of the exhaust mixer, a size and/or volume of the at least one damping cavity, an internal surface area of the at least one damping cavity, a density of the at least one damping cavity and/or the damping medium, a packing density of the damping medium, or a density and/or size of particles of the damping medium.

These and other features of the present disclosure will become more apparent from the following description of the illustrative embodiments.

### BRIEF DESCRIPTION OF THE DRAWINGS

FIG. 1 is a cutaway view of a gas turbine engine that includes a fan, a bypass duct, an engine core having a compressor, a combustor, and a turbine, and an exhaust mixer, the fan including a fan rotor configured to rotate about a central axis of the engine, and showing that the exhaust mixer is arranged aft of the engine core and is configured to mix bypass air exiting the bypass duct and gases exiting the engine core before exhausting the mixture aft of the engine;

FIG. 2 is an axially-facing view of the exhaust mixer of FIG. 1, showing that the exhaust mixer includes an annular wall having a plurality of inner and outer lobes and a plurality of damping cavities arranged on or at least partially within the inner lobes;

FIG. 3 is a perspective view of the exhaust mixer of FIG. 2;

FIG. 4 is a top perspective view of the exhaust mixer of FIG. 2, showing that the plurality of damping cavities includes a plurality of first damping cavities formed within first inner lobes of the plurality of inner lobes and a plurality of second damping cavities formed within second inner lobes of the plurality of inner lobes, the first damping cavities having a larger volume than the second damping cavities;

FIG. 5 is a top radially-facing view of a portion of the exhaust mixer of FIG. 4, showing one of the first damping cavities formed in a first inner lobe and two second damping cavities formed in second inner lobes on opposing circumferential sides of the first inner lobe and first damping cavity;

FIG. 6 is a side circumferentially-facing cross-sectional view of the exhaust mixer of FIG. 4, showing the axial and radial extents of a first damping cavity and a second damping cavity, shown partially in phantom lines;

FIG. 7A is an axially-facing cross-sectional view of a first damping cavity of the plurality of damping cavities and a first inner lobe of the plurality of inner lobes of FIG. 4, showing that the first damping cavity is defined between inner and outer walls of the inner lobe;

FIG. 7B is an axially-facing cross-sectional view of a second damping cavity of the plurality of damping cavities and a second inner lobe of the plurality of inner lobes of FIG. 4, showing that the second damping cavity is defined between inner and outer walls of the inner lobe;

FIG. 8A is an axially-facing view of an alternative configuration of the damping medium within the damping cavities of FIG. 4 with the aft end wall of the cavity removed so the interior of the cavity can be viewed, showing the alternative configuration in the context of the exhaust mixer of FIGS. 9-13, showing that a loose mass that is coupled to an inner wall of the damping cavity is suspended within the damping medium;

FIG. 8B is an axially-facing view of an alternative configuration of the damping medium within the damping cavities of FIG. 4 with the aft end wall of the cavity removed so the interior of the cavity can be viewed, showing the alternative configuration in the context of the exhaust mixer of FIGS. 9-13, showing that a loose mass suspended within the damping medium;

FIG. 8C is a top view of surface features of one or more of the outer and inner walls of the damping cavities of FIG. 4, showing that a lattice structure may be formed on the outer or inner walls of the damping cavities on surfaces that face the damping cavity;

FIG. 8D is a top view of surface features of one or more of the outer and inner walls of the damping cavities of FIG. 4, showing that wave structures may be formed on the outer or inner walls of the damping cavities on surfaces that face the damping cavity;

FIG. 8E is a top view of surface features of one or more of the outer and inner walls of the damping cavities of FIG. 4, showing that a parallel row structure may be formed on the outer or inner walls of the damping cavities on surfaces that face the damping cavity;

FIG. 9 is an axially-facing view of an exhaust mixer according to a further aspect of the present disclosure and configured to be utilized in the gas turbine engine of FIG. 1, showing that the exhaust mixer includes an annular wall having a plurality of inner and outer lobes and a plurality of damping cavities arranged on or at least partially within the outer lobes;

FIG. 10 is a top perspective view of the exhaust mixer of FIG. 9, showing that the plurality of damping cavities includes a plurality of first damping cavities formed within the outer lobes;

FIG. 11 is a side circumferentially-facing cross-sectional view of the exhaust mixer of FIG. 9, showing the axial and radial extents of a first damping cavity;

FIG. 12 is an axially-facing cross-sectional view of a damping cavity of the plurality of damping cavities of FIG. 9 with the aft end wall of the cavity removed so the interior of the cavity can be viewed, showing that the damping cavity is defined between radially outer top wall and an inner wall of the outer lobe;

FIG. 13 is a bottom perspective view of the damping cavity of FIG. 12;

FIG. 14 is an axially-facing view of an exhaust mixer according to a further aspect of the present disclosure and configured to be utilized in the gas turbine engine of FIG. 1, showing that the exhaust mixer includes a plurality of raised enclosures having damping cavities arranged therein, the plurality of raised enclosures being arranged on radially outer surfaces of the outer lobes;

FIG. 15 is a top perspective view of a portion of the exhaust mixer of FIG. 14, showing that the plurality of raised enclosures includes groups of raised enclosures formed on the radially outer surfaces of the outer lobes;

FIG. 16A is a top radially-facing view of a portion of the exhaust mixer of FIG. 14, showing that the groups of raised enclosures include three unique raised enclosures in alternating arrangements about the circumference of the exhaust mixer;

FIG. 16B is a magnified top radially-facing view of one of the groups of raised enclosures of FIG. 16A;

FIG. 17 is a raised axially-facing view of one of the groups of raised enclosures of FIG. 16A with a portion of the area of the annular wall forward of the raised enclosures removed so the raised enclosures can be viewed;

FIG. 18 is a side circumferentially-facing view of the raised enclosures of FIG. 14 on a portion of the exhaust mixer; and

FIG. 19 is an axially-facing cross-sectional view showing the damping cavities of the raised enclosures of FIG. 14.

### DETAILED DESCRIPTION

For the purposes of promoting an understanding of the principles of the disclosure, reference will now be made to a number of illustrative embodiments illustrated in the drawings and specific language will be used to describe the same.

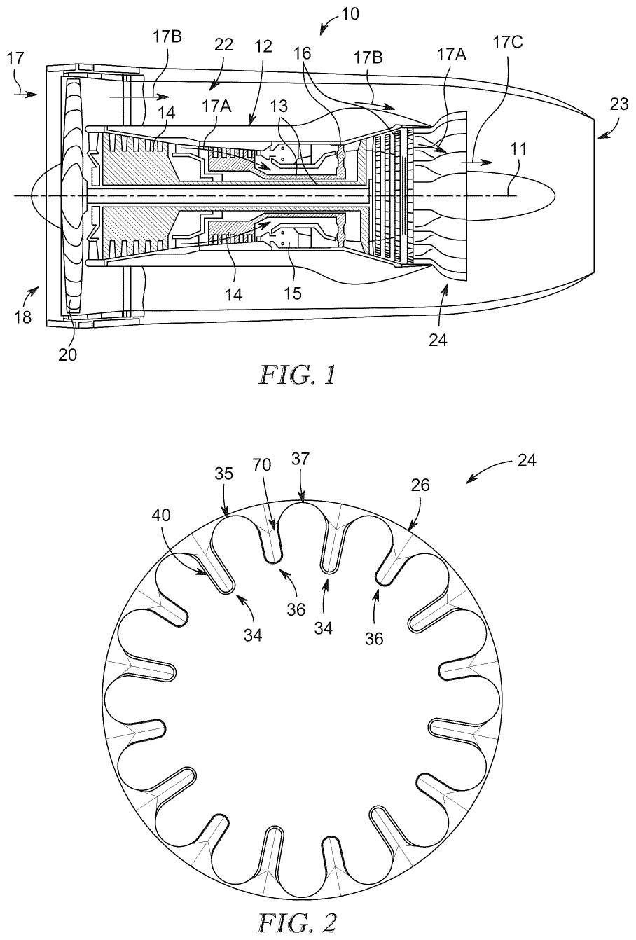

A gas turbine engine 10 in accordance with the present disclosure is shown in FIG. 1 and includes an engine core 12 and a fan assembly 18 having a fan rotor 20 (also referred to herein as an “inlet fan”) arranged upstream of the engine core 12. The engine core 12 is configured to compress and combust air 17 entering the gas turbine engine 10 to drive rotation of one or more shafts 13 about a central axis 11 of the gas turbine engine 10. The one or more shafts 13 interconnect the engine core 12 and the fan rotor 20 to cause rotation of the fan rotor 20 and to provide thrust for the gas turbine engine 10.

The engine core 12 includes a compressor 14, a combustor 15, and a turbine 16. The compressor 14 includes one or more stages of rotating blades that compress a first portion 17A of the air 17 having been directed by the fan rotor 20 and into the engine core 12 and produce pressurized air (first portion 17A of the air 17) which is transferred downstream to the combustor 15. The combustor 15 is configured to mix fuel with the pressurized air 17A and combust the fuel and pressurized air 17A to produce combustion products which are transferred downstream to the turbine 16. The turbine 16 also includes one or more stages of rotating blades which are coupled to the one or more shafts 13 and are driven in rotation about the central axis 11. Rotation of the one or more shafts 13 causes rotating components of the fan rotor 20 to rotate about the central axis 11.

A second portion 17B of the air 17 is directed from the fan rotor 20 through a bypass duct 22 located aft of the fan rotor 20 and at least partially radially surrounding the engine core 12 about the central axis 11. The second portion 17B of the air 17 passes through the bypass duct 22 to an exhaust mixer 24 arranged aft of the engine core 12 and the bypass duct 22. The exhaust mixer 24 is configured to mix the second portion 17B of air 17 exiting the bypass duct 22 and the first portion 17A of air 17 exiting the engine core 12 and subsequently exhaust the mixture 17C of the first and second portions 17A, 17B of air 17 of the aft of the engine 10 via an exhaust nozzle 23.

According to a first aspect of the present disclosure, the exhaust mixer 24 of the gas turbine engine 10 includes at least one damping cavity 40, 70. The damping cavities 40, 70 each include a damping medium 58, 88 arranged therein. Movement of the damping medium 58, 88 within the damping cavities 40, 70 can damp vibrations of the exhaust mixer 24 caused during operation of the gas turbine engine 10.

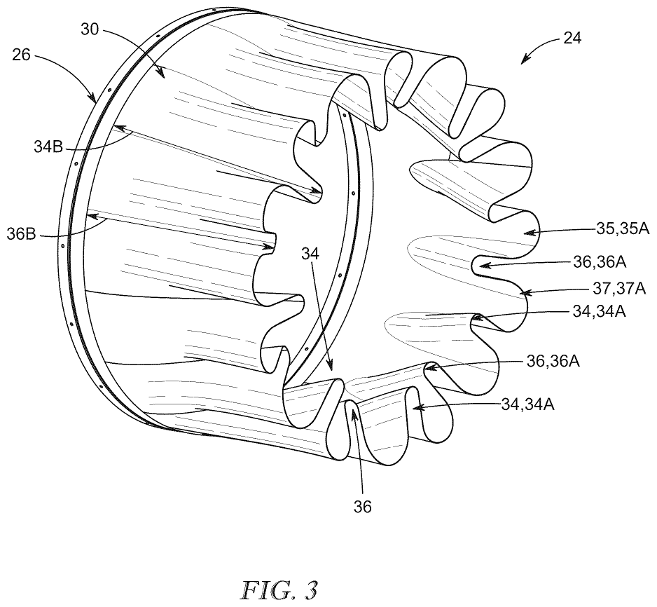

As can be seen in FIG. 3, the exhaust mixer 24 includes a forward annular ring 26 defining a forward end of the exhaust mixer 24 and that extends around the central axis 11. The annular ring 26 may be coupled to an aft end of the engine core 12. The exhaust mixer 24 further includes an annular wall 30 coupled to and located aft of the annular ring 26, the annular wall 30 extending aft away from the annular ring 26 and extending around the central axis 11.

The annular wall 30 includes a plurality of inner lobes 34, 36 that each define a first channel 34A, 36A therein that opens radially outwardly, as shown in FIG. 3. The annular wall 30 further includes a plurality of outer lobes 35, 37 that each define a second channel 35A, 37A therein that opens radially inwardly. As can be seen in FIGS. 2 and 3, the annular wall 30 alternates between inner lobes 34, 36 and outer lobes 35, 37 so as to form a flower-type shape when viewing the exhaust mixer 24 in the axial direction, as shown in FIG. 2.

The inner lobes 34, 36 may include first inner lobes 34 having a first axial extent 34B as measured from the annular ring 26 and second inner lobes 36 having a second axial extent 36B as measured from the annular ring 26, as shown in FIG. 3. The damping cavities 40, 70 include first damping cavities 40 arranged on or within the first inner lobes 34 and second damping cavities 70 arranged on or within the second inner lobes 36. Illustratively, the first and second damping cavities 40, 70 are arranged at least partially within the lobes 34, 36, specifically in embodiments in which the inner walls 46A, 46B, 76A, 76B are considered part of the lobes 34, 36 and thus the outer and inner walls 42A, 42B, 72A, 72B, 46A, 46B, 76A, 76B define the cavities 40, 70 therein. In other embodiments in which the inner walls 46A, 46B, 76A, 76B are not considered part of the lobes 34, 36, the cavities 40, 70 may be arranged “on” the lobes 34, 36. In other embodiments in which the cavities may be arranged “on” the lobes, the cavities may be formed within enclosures formed on the lobes, as will be described in greater detail below.

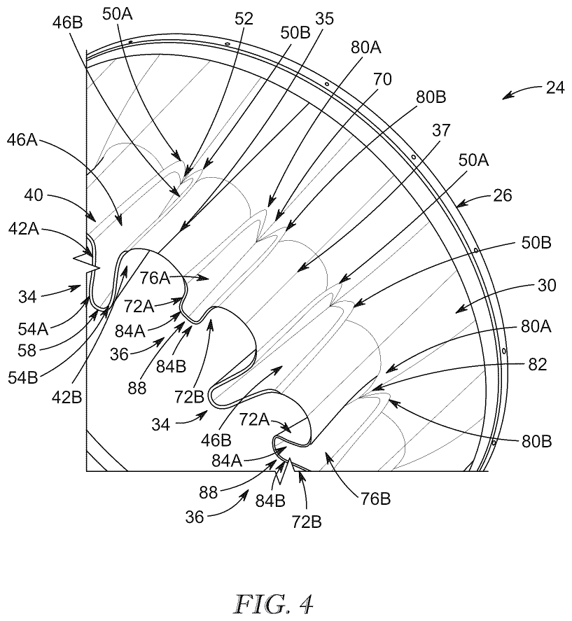

Illustratively, the first axial extent 34B is longer than the second axial extent 36B, as shown in FIG. 3, and thus, the first inner lobes 34 are larger than the second inner lobes 36, at least as measured in the axial direction. As a result, because the first and second damping cavities 40, 70 begin at approximately the same location axially on the lobes 34, 36, as shown in FIG. 4, the first damping cavities 40 are larger than the second damping cavities 70, at least in that the first damping cavities 40 define a larger interior space than the second damping cavities 70 within which the damping medium 58, 88 is arranged.

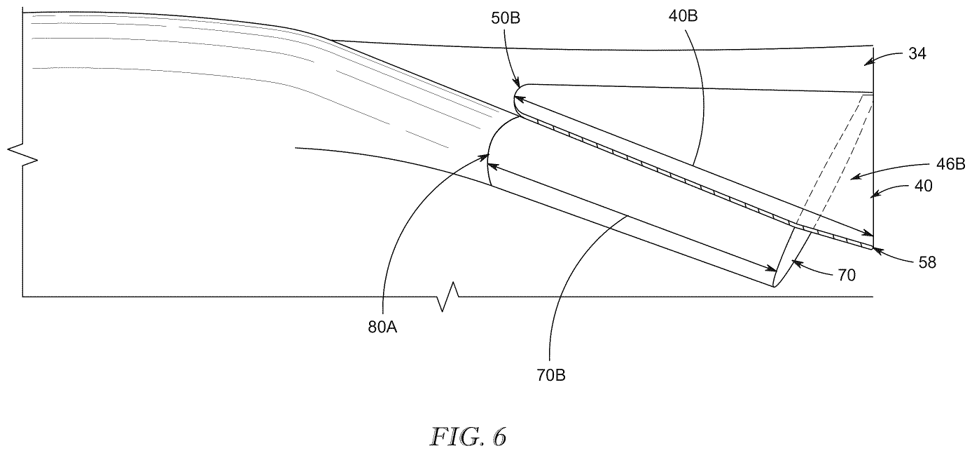

As can be seen in FIGS. 4-6, in at least some embodiments, the damping cavities 40, 70 can be begin approximately halfway along an axial extent of the annular wall 30. It is noted, as will be described in detail below, the size, position, and other parameters can vary via selective fabrication of the damping cavities 40, 70 via the additive layer manufacturing processes described herein. Each damping cavity 40, 70 can terminate at the aft end of the annular wall 30, although in other embodiments, the damping cavities 40, 70 may be formed to terminate before the aft end. As noted above, because the damping cavities 40, 70 begin at approximately the same axial location, a length of the first damping cavities 40, as measured in the axial and radial directions as shown in FIG. 6, is greater than a length of the second cavities 70 as measured in the same direction.

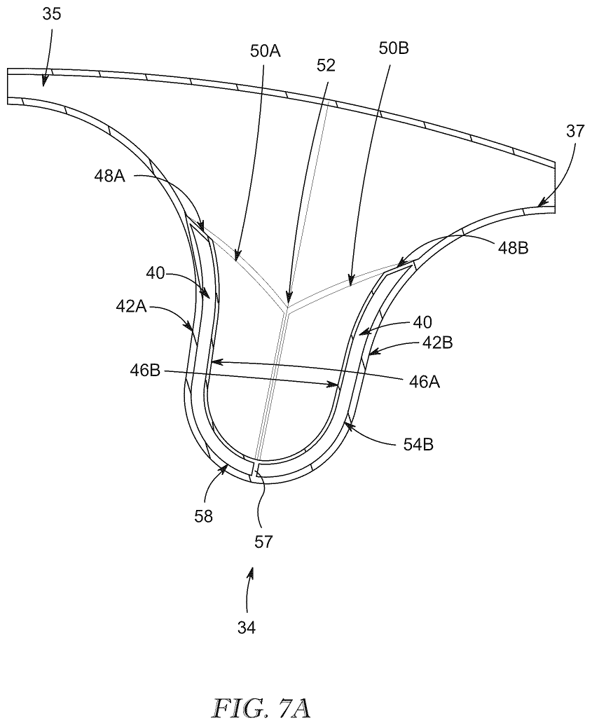

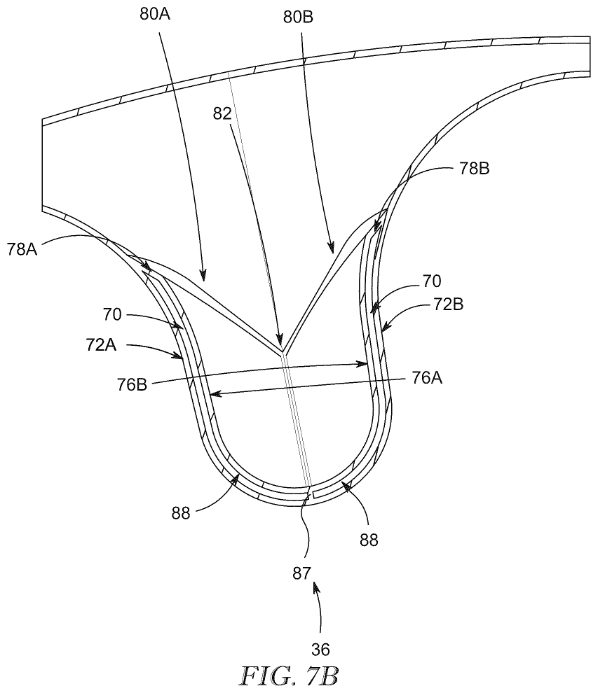

Exemplary first and second cavities 40, 70 configured to be utilized in the annular wall 30 of the exhaust mixer shown in FIGS. 2-6 are shown in FIGS. 7A and 7B. It is noted that, although the first damping cavities 40 are shown to have a slightly wider area for the damping medium 58 than the second cavities 70 and its damping medium 88, this is merely exemplary. Because the first and second cavities 40, 70 as shown and described with regard to FIGS. 7A and 7B are formed substantially similarly, albeit with the second cavities 70 having the slightly shorter length than the first damping cavities 40 as described above, the width of the first damping cavities 40 may be utilized in the second cavities 70, and vice versa.

As can be seen in FIG. 7A, the first damping cavities 40 can each be defined by a first outer wall 42A on a first side of the first inner lobe 34 that defines the cavity 40, and a second outer wall 42B on the opposing second side of the inner lobe 34. The outer walls 42A, 42B may be defined by the portion of the annular wall 30 that defines the lobe 34. The inner walls 46A, 46B of the lobe 34 may also be part of the annular wall 30 and are spaced apart from the outer walls 42A, 42B in a direction towards a center of the lobe 34.

Illustratively, the inner walls 46A, 46B match the contour of the outer walls 42A, 42B, although the shape of the outer and inner walls 42A, 42B, 46A, 46B, and thus the shapes of the cavity 40, can be tailored based on the design requirements and/or the predicted vibratory responses of the exhaust mixer 24. Although the cavity 40 is shown as being defined between outer and inner walls 42A, 42B, 46A, 46B, in some other embodiments, the annular wall 30 may be formed to be thick enough or wide enough such that the cavity 40 may be formed within the annular wall 30 in the area of the lobe 34 instead of including the inner walls 46A, 46B.

In some embodiments, one or more support walls 57 may extend from the outer wall 42A, 42B to the inner wall 46A, 46B so as to provide structural support to the inner wall 46A, 46B. In one exemplary embodiment, the support wall 57 may be arranged at a radially innermost point of the lobe 34 at which the first and second sides of the lobe 34 meet.

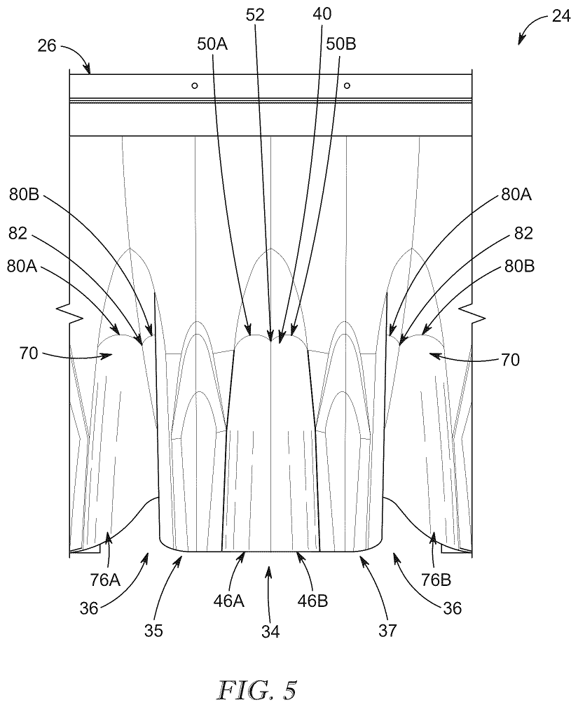

As shown in FIG. 7A, the inner walls 46A, 46B extend radially outwardly along the outer walls 42A, 42B until the walls 46A, 46B terminate at an end wall 48A, 48B. Illustratively, the end walls 48A, 48B extend away from a portion of the annular wall 30 generally located where the inner lobes 34 transition into the outer lobes 35, 37. As can be more clearly seen in FIGS. 4 and 5, the inner walls 46A, 46B extend axially forward from the aft end of the annular wall 30 toward the annular ring 26. In some embodiments, the inner walls 46A, 46B begin to curve as they near the axially forwardmost end of the cavity 40. In particular, each inner wall 46A, 46B includes an axially forward end 50A, 50B that is curved, each axially forward end 50A, 50B converging toward an axially forward center point 52 of the cavity 40. In this way, the cavity 40, as defined on the first side of the lobe 34 by the outer and inner walls 42A, 46A and the second side of the lobe 34 by the outer and inner walls 42B, 46B, is delimited by the aft end of the annular wall 30 and the axially forward ends 50A, 50B.

Similar to first damping cavities 40, the second cavities 70 are formed to each be defined by a first outer wall 72A on a first side of the inner second lobe 36 and a second outer wall 72B on the opposing second side of the inner lobe 36, as shown in FIG. 7B. The outer walls 72A, 72B may be defined by the portion of the annular wall 30 that defines the lobe 36. The inner walls 76A, 76B of the lobe 36 may also be part of the annular wall 30 and are spaced apart from the outer walls 72A, 72B in a direction towards a center of the lobe 36.

Illustratively, the inner walls 76A, 76B match the contour of the outer walls 72A, 72B, although the shape of the outer and inner walls 72A, 72B, 76A, 76B, and thus the shapes of the cavity 70, can be tailored based on the design requirements and/or the predicted vibratory responses of the exhaust mixer 24. Although the cavity 70 is shown as being defined between outer and inner walls 72A, 72B, 76A, 76B, in some other embodiments, the annular wall 30 may be formed to be thick enough or wide enough such that the cavity 70 may be formed within the annular wall 30 in the area of the lobe 36 instead of including the inner walls 76A, 76B.

In some embodiments, one or more support walls 87 may extend from the outer wall 72A, 72B to the inner wall 76A, 76B so as to provide structural support to the inner wall 76A, 76B. In one exemplary embodiment, the support wall 87 may be arranged at a radially innermost point of the lobe 36 at which the first and second sides of the lobe 36 meet.

As shown in FIG. 7B, the inner walls 76A, 76B extend radially outwardly along the outer walls 72A, 72B until the walls 76A, 76B terminate at an end wall 78A, 78B. Illustratively, the end walls 78A, 78B extend away from a portion of the annular wall 30 generally located where the inner lobes 36 transition into the outer lobes 35, 37. As can be more clearly seen in FIGS. 4 and 5, the inner walls 76A, 76B extend axially forward from the aft end of the annular wall 30 toward the annular ring 26. In some embodiments, the inner walls 76A, 76B being to curve as they near the axially forwardmost end of the cavity 70. In particular, each inner wall 76A, 76B includes an axially forward end 80A, 80B that is curved, each axially forward end 80A, 80B converging toward an axially forward center point 82 of the cavity 70. In this way, the cavity 70, as defined on the first side of the lobe 36 by the outer and inner walls 72A, 76A and the second side of the lobe 36 by the outer and inner walls 72B, 76B, is delimited by the aft end of the annular wall 30 and the axially forward ends 80A, 80B.

Each damping cavity 40, 70 is filled with a damping medium 58, 88. Illustratively, the damping medium 58, 88 can comprise powder utilized during the additive layer manufacturing process described herein. Specifically, the additive layer manufacturing process begins with the additive material (e.g. a powder) being laid on a build platform of an additive layering machine. This layer is subsequently shaped and solidified via an energy source (e.g. a laser or other high-energy source), and subsequent layers are formed in the same manner on top of previous layers to ultimately form the final part. This additive layer manufacturing process can include any process known in the art, such as, for example, laser powder bed fusion (LPBF) and similar techniques.

During the fabrication of the exhaust mixer 24, the damping cavities 40, 70 are manufactured in these layers, during which powder is laid, shaped, and solidified layer-by-layer. In the areas of the damping cavities 40, 70, powder can be laid between the areas of the outer and inner walls 42A, 42B, 46A, 46B and can be left in a powder state during manufacture of the remainder of the cavities 40, 70. Thus, after the cavities 40, 70 are completed, they are filled, entirely or partially, with the loose powder which constitutes the damping medium 58, 88.

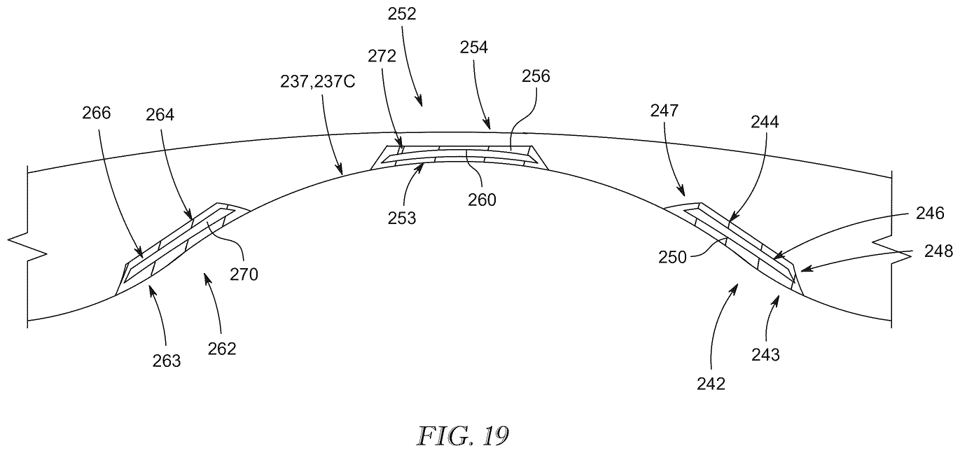

In some embodiments, the damping medium 58, 88 can include a material other than the layering powder. In such embodiments, the lobes 34, 35, 36, 37 may be formed with passages connecting the cavities 40, 70 to the outside environment so that the cavities 40, 70 can be filled with the damping medium 58, 88. For example, a passage 272 is shown in FIG. 19. Similar passages can be formed in other embodiments, such as, for example, a similar passage that extends from the cavity 40, through the inner wall 42A, and to the outside environment, or a similar passage extends from the cavity 140, through the wall 146, and to the outside environment. These passages can be closed subsequent to the filling of the cavities 40, 70. These passages could also be included so that some powder formed by the previously-described process can be removed in post-processing of the exhaust mixer 24. In some embodiments, the material other than the layering powder may include, by way of non-limiting example, one or more of sand, glass, an alternative metal powder, plastic pellets, shear thickening fluid (non-Newtonian), or epoxy putty.

Via additive layer manufacturing, the exhaust mixer 24, and thus the annular wall 30, the lobes 34, 35, 36, 37, and the damping cavities 40, 70 of the lobes 34, 36 arranged around the annular extent of the exhaust mixer 24, are configured to be selectively formed into desired shapes and geometries, which provides great flexibility and freedom in designing the cavities 40, 70 in order to account for a wide variety of designs and usage scenarios of the exhaust mixer 24. During operation of the engine 10, the mixing of the first and second portions 17A, 17B of the air 17, as well as other aeromechanical and purely mechanical influences of the components of the engine 10, can cause a negative dynamic response on the exhaust mixer 24 which can lead to failure of the exhaust mixer 24. Non-limiting examples of the causes of influences affecting dynamic response can include, but are not limited to, vibrations of the shafts 13, imbalances in the various rotating components, minor misalignments in components, turbulence in the air flow, and the like.

To aid in mitigating such negative dynamic responses in the exhaust mixer 24, the exhaust mixer 24 can include one or more of the damping cavities 40, 70 described above (as well as the alternative arrangements of damping cavities described below) in order to damp vibrations in the exhaust mixer 24. Illustratively, the exhaust mixer 24 includes damping cavities 40, 70 arranged about its entire annular extent, and each damping cavity 40, 70 is formed so as to selectively effect at least one parameter of the damping cavities 40, 70.

Utilizing additive layer manufacturing allows for one or more of the at least one parameters of the damping cavities 40, 70 to be selectively chosen during fabrication of the exhaust mixer 24. For example, the parameters of the damping cavities 40, 70 that can selectively effected during and via the additive layer manufacturing process includes a location of the damping cavities 40, 70 on the inner or outer lobes 34, 35, 36, 37 (i.e. in an area of maximum deflection), a size and/or volume of the damping cavities 40, 70, an internal surface area (i.e. a surface area of the outer and/or inner walls 42A, 42B, 46A, 46B, 72A, 72B, 76A, 76B) of the damping cavities 40, 70, a density of the outer and/or inner walls 42A, 42B, 46A, 46B, 72A, 72B, 76A, 76B of the damping cavities 40, 70 and/or the damping medium 58, 88, a packing density of the damping medium 58, 88, or a density and/or size of particles of the damping medium 58, 88. These parameters are merely exemplary, and any other features and parameters of the damping cavities 40, 70 may be selectively chosen when forming the cavities 40, 70, such as other dimensions, materials, and the like.

In some embodiments, the fabrication of the damping cavities 40, 70, and thus the setting of the parameters described above, can be based on a predicted vibratory response of the exhaust mixer 24, in particular a predicted vibratory response that will occur during operation of the gas turbine engine 10 such that movement of the damping medium 58, 88 within the damping cavities 40, 70 damps vibrations of the exhaust mixer 24. By way of non-limiting example, the vibratory response may be predicted via a modal analysis of the exhaust mixer 24, a forced response analysis, or other similar analysis.

The damping or mistuning of the vibratory response can occur due to the effects of various principles, each which can be intentionally induced via the formation of the damping cavities 40, 70 and the damping medium 58, 88 properties. For example, the embodiments described above with regard to FIGS. 2-7B can damp or mistune the vibratory response via frictional and/or coulomb damping. Specifically, particles of the powder comprising the damping medium 58, 88 can rub against each other during operation of the engine 10 due to a negative dynamic response which results in a deflection with amplitude. The rubbing of the particles against each other will dissipate energy, thus damping the vibratory response. Moreover, the particles moving across the inner surfaces of the cavities 40, 70 may cause frictional damping.

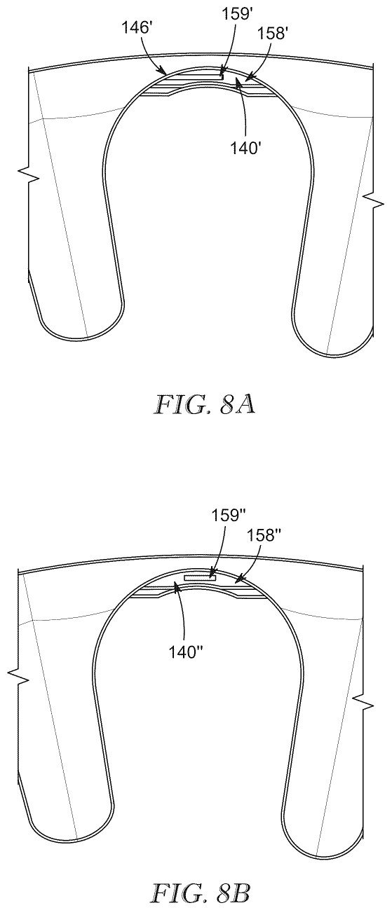

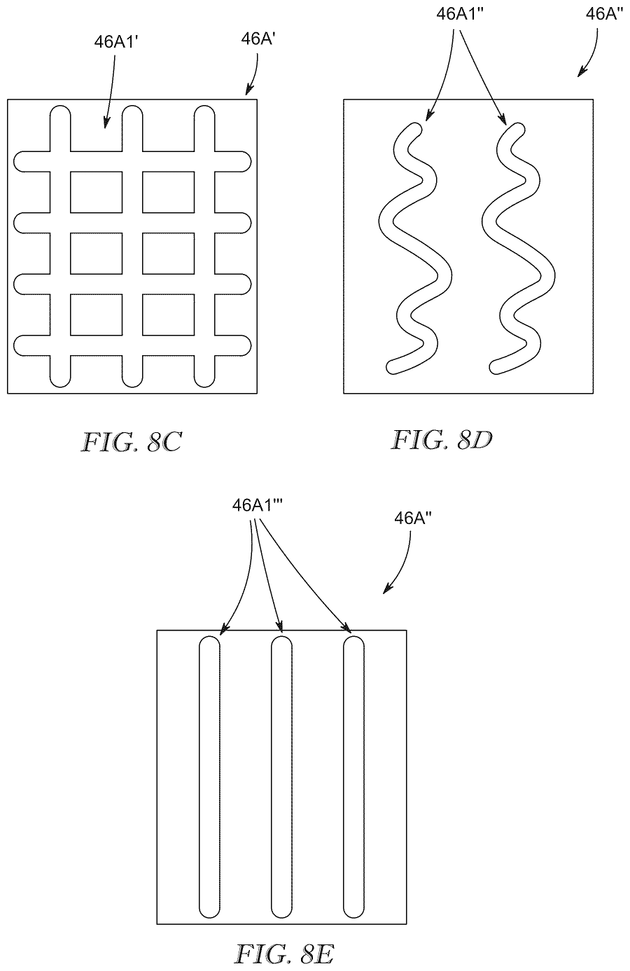

In some embodiments, such as those shown in FIGS. 8C-8E, the inner surfaces of the cavities 40, 70, specifically the inner surfaces of the outer and/or inner walls 42A, 42B, 46A, 46B, 72A, 72B, 76A, 76B facing the cavities 40, 70, may include various structures formed therein or thereon to further effect the frictional damping caused by the particles of the damping medium 58, 88 rubbing on those surfaces. These structures can be formed via the additive layer manufacturing processes described herein, and may include structures that may not be machinable via conventional methods. For example, as shown in FIGS. 8C, 8D, and 8E, which show the inner wall 46A′, 46A″, 46A′″ as examples, the inner surfaces may include lattice designs 46A1′, wave designs 46A1″, or parallel line designs 46A1′″. These structures may be formed as grooves, ribs, or a combination of both.

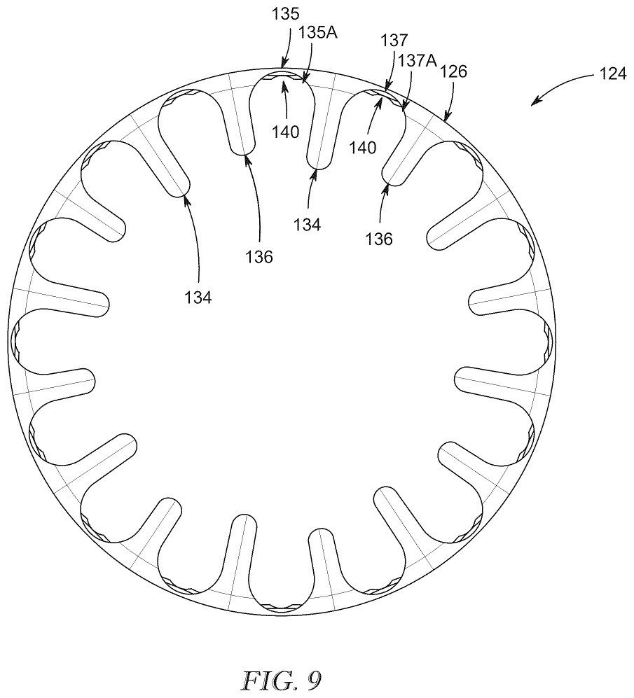

The damping or mistuning of the vibratory response can also occur due to mass phase shift damping, as shown in the examples shown in FIGS. 8A and 8B. Although these examples are shown with relation to the embodiment of FIGS. 9-13 and the damping cavity 140, the same principles apply to the other damping cavities described herein and can be applied thereto. Mass phase shift damping may include arranging an additional solid member 159′, 159″ within the cavity 140′, 140″, in particular within the damping medium 158′, 158″. When the exhaust mixer 24 begins to respond to vibrations, the particles of the damping medium 158′, 158″ will “lag” behind the vibrational amplitude of the exhaust mixer 24 and thus the additional solid member 159′, 159″. This will create a damping effect, as the particles of the damping medium 158′, 158″ will provide resistance against the movement of the additional solid member 159′, 159″.

In some embodiments, as shown in FIG. 8A, the additional solid member 159′ can be coupled to a wall 146′ of the cavity 140′ so that the additional solid member 159′ is cantilevered from the wall 146′. In other embodiments, as shown in FIG. 8B, the additional solid member 159″ can be entirely separate from the walls 142″, 146″ of the cavity 140″ and thus suspended therein.

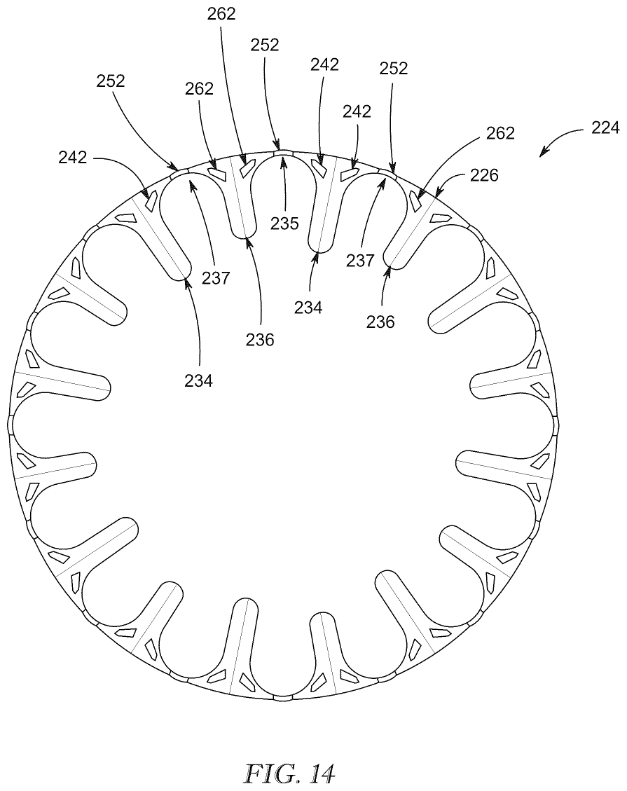

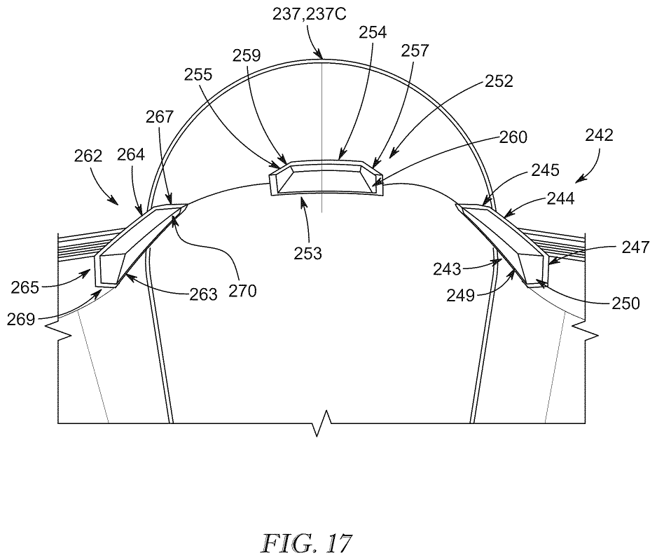

In some embodiments, as shown in FIGS. 14-19, the damping or mistuning of the vibratory response can also occur due to bending deformation, in particular with individual raised enclosures 242, 252, 262 arranged in areas of maximum deflection or strain, or where the bending actually occurring. As the raised enclosures 242, 252, 262 bend, and thus the damping cavities 249, 259, 269 defined within the enclosures 242, 252, 262 bend, the particles of the damping mediums 250, 260, 270 inside the cavities 249, 259, 269 are squeezed together. As the cavities 249, 259, 269 change shape and pinch in, the particles of the damping mediums 250, 260, 270 will move into vacant space through contact with other particles as well as the inner surfaces of the raised enclosures 242, 252, 262, thus creating a damping effect.

Forming the exhaust mixer 24 and its damping cavities 40, 70 via additive layer manufacturing as one monolithic component that is formed in a single fabrication process (or, alternatively, physically separate components that are formed disconnected from each other, at least in some areas, during an uninterrupted, layer-by-layer, single fabrication process and overall form the exhaust mixer 24) can provide numerous advantages. For example, because multiple fabrication or machining processes of various parts of the exhaust mixer 24 can all be completed in one single fabrication process via additive layer manufacturing, additional time and cost for completing multiple processes is eliminated. Moreover, improvements in the ability to manipulate natural frequencies of exhaust mixers are realized by the present disclosure. Even further, modifications to the design of the exhaust mixer can quickly be applied and tested via being able to quickly produce the modified exhaust mixer via additive layer manufacturing. It is noted that this process can also be referred to as “advanced manufacturing.”

A method according to a further aspect of the present disclosure includes arranging an engine core 12 about a central axis 11 of a gas turbine engine 10, the engine core 12 configured to combust a first portion 17A of air 17 entering the gas turbine engine 10 and exhaust the combusted air 17 aft of the engine core 12, providing a fan assembly 18 including an inlet fan 20 arranged forward of the engine core 12 and a bypass duct 22 located aft of the inlet fan 20 and at least partially radially surrounding the engine core 12, the inlet fan 20 directing the first portion 17A of air 17 into the engine core 12 and a second portion 17B of air 17 into the bypass duct 22, and forming an exhaust mixer 24 via additive layer manufacturing and arranging the exhaust mixer 24 aft of the engine core 12 and the bypass duct 22, the exhaust mixer 24 being configured to mix the second portion 17B of air 17 exiting the bypass duct 22 and the first portion 17A of air 17 exiting the engine core 12 and subsequently exhaust the mixture 17C of the first and second portions 17A, 17B of air 17 aft of the engine 10.

The forming of the exhaust mixer 24 can include forming an annular wall 30 extending about the central axis 11, the annular wall 30 having a plurality of inner lobes 34, 36 that each define a first channel 34A, 36A therein that opens radially outwardly and a plurality of outer lobes 35, 37 that each define a second channel 35A, 37A therein that opens radially inwardly, and forming at least one damping cavity 40, 70 on or at least partially within the annular wall 30 on an inner lobe 34, 36 or an outer lobe 35, 37 of the plurality of inner and outer lobes 34, 35, 36, 37, the at least one damping cavity 40, 70 being formed to include a damping medium 58, 88 arranged therein such that movement of the damping medium 58, 88 within the at least one damping cavity 40, 70 damps vibrations of the exhaust mixer 24.

In some embodiments, the method can further include determining a predicted vibratory response of the exhaust mixer 24 that occurs during operation of the gas turbine engine 10, and selectively forming the at least one damping cavity 40, 70 in order to effect at least one parameter of the at least one damping cavity 40, 70 based on the predicted vibratory response of the exhaust mixer 24.

Another embodiment of an exhaust mixer 124 configured to be utilized in the gas turbine engine 10 is shown in FIGS. 9-13. The exhaust mixer 124 is similar to the exhaust mixer 24 described herein. Accordingly, similar reference numbers in the 100 series indicate features that are common between the exhaust mixer 124 and the exhaust mixer 24. The description of the exhaust mixer 24 is incorporated by reference to apply to the exhaust mixer 124, except in instances when it conflicts with the specific description and the drawings of the exhaust mixer 124.

The exhaust mixer 124 is formed substantially similarly to the exhaust mixer 24 described herein, in particular including the annular ring 126 and multiple inner and outer lobes 134, 135, 136, 137 arranged around the circumference of the exhaust mixer 124. The exhaust mixer 124 differs in that, instead of including damping cavities in the inner lobes 134, 136, the damping cavities 140 are located in one or more of the outer lobes 135, 137, and illustratively, in each outer lobe 135, 137.

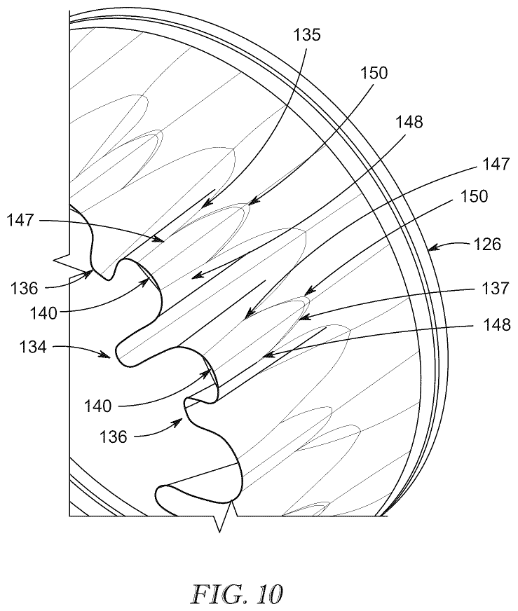

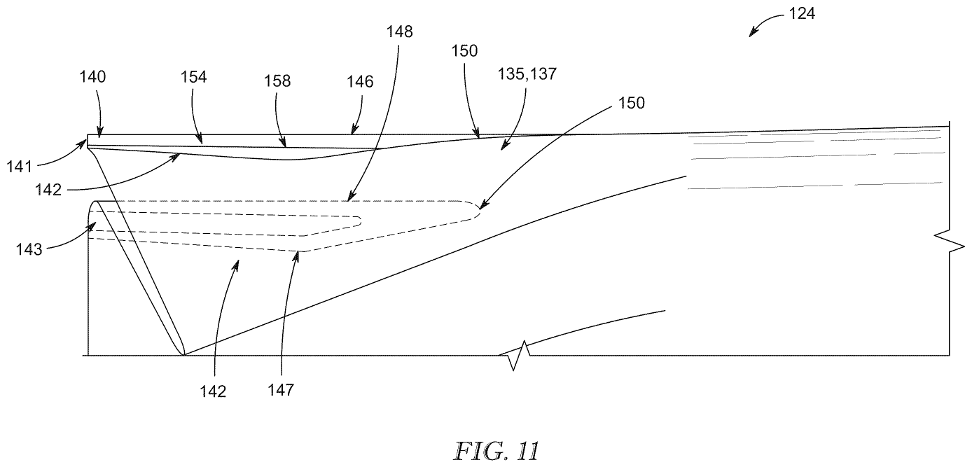

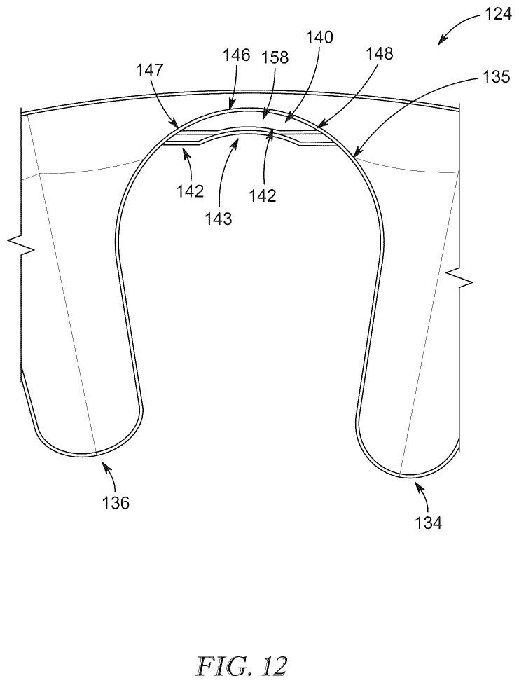

As shown in FIGS. 9 and 10, and in greater detail in FIGS. 11-13, each cavity 140 is formed within the second channel 135A, 137A defined by the outer lobes 135, 137. Specifically, each cavity 140 is formed in a radially outer side of the outer lobe 135, 137, and is defined by an inner wall 142 (also referred to herein as a “second wall”) that extends between spaced apart locations on the outer lobe 135, 137, as shown in FIG. 12. The inner wall 142 is spaced apart from a radially outer wall 146 of the lobe 135, 137, which may part of the portion of the annular wall 130 that defines the lobe 135, 137. Both the inner and outer walls 142, 146 may be considered part of the annular wall 130. In some embodiments, the cavity 140 can extend axially from one axially aftmost side of the lobe 135, 137 halfway toward the annular ring 126.

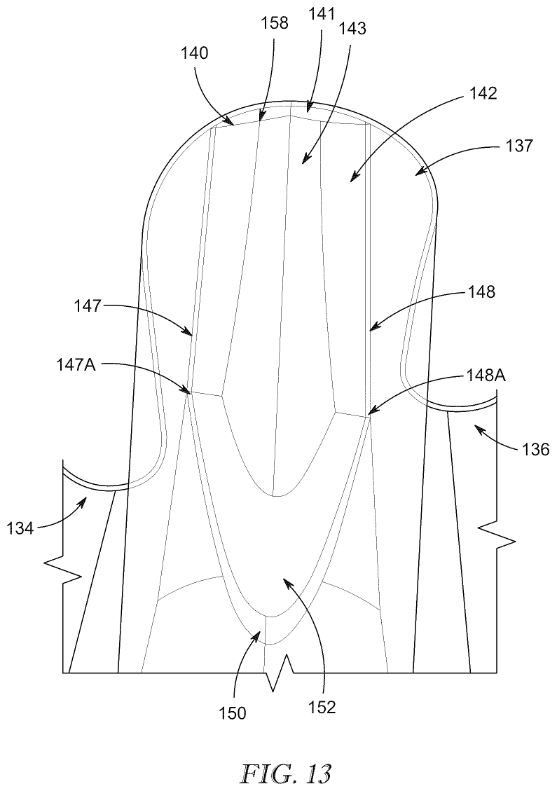

As can be seen in greater detail in FIGS. 11 and 13, the damping cavity 140 may be further defined by a first side 147 and a second side 148 opposite the first side 147 of the inner wall 142 that each extend generally axially away from the aft end of the annular wall 130. The first and second sides 147, 148 may run generally parallel with each other until they reach a transition point 147A, 148A at which the first and second sides 147, 148 begin to curve toward each other and meet at a connection point 150 so as to define a U-shaped surface 152 on the inner wall 142, as shown in FIG. 13. An aft wall 141 may be arranged to the aft end of the cavity 140 so as to completely enclose the cavity 140. It is noted that, while this general shape of the damping cavity 140 may provide damping effects for certain vibratory responses, the properties of the cavity 140, such as those related to the parameters discussed above, can be tailored based on specific predicted or known vibratory responses of the mixer 124 during operation of the engine 10 via additive layer manufacturing.

In some embodiments, the inner wall 142 further includes a recess 143 that extends axially from the aft end of the wall 142 to the U-shaped surface 152. Illustratively, the recess 143 includes a curved inner surface that extends axially along the length of the recess 143. The recess 143 may provide additional damping benefits for particular operating scenarios of the engine 10 and/or predicted vibratory responses.

Another embodiment of an exhaust mixer 224 configured to be utilized in the gas turbine engine 10 is shown in FIGS. 14-19. The exhaust mixer 224 is similar to the exhaust mixers 24, 124 described herein. Accordingly, similar reference numbers in the 200 series indicate features that are common between the exhaust mixer 224 and the exhaust mixers 24, 124. The description of the exhaust mixers 24, 124 are incorporated by reference to apply to the exhaust mixer 224, except in instances when it conflicts with the specific description and the drawings of the exhaust mixer 224.

The exhaust mixer 224 is formed similarly to the exhaust mixers 24, 124 described herein, in particular including the annular ring 226 and multiple inner and outer lobes 234, 235, 236, 237 arranged around the circumference of the exhaust mixer 224. The exhaust mixer 224 differs in that, as opposed to having cavities arranged on or within the channels defined by the lobes 234, 235, 236, 237, the exhaust mixer 224 includes a plurality of raised enclosures 242, 252, 262 formed on one or more radially outer sides 235C, 237C of one of the plurality of outer lobes 235, 237. Although not shown, the present disclosure contemplates raised enclosures being arranged on the outer surfaces of the inner lobes 234, 236 in addition to or alternative to the raised enclosures 242, 252, 262 described herein.

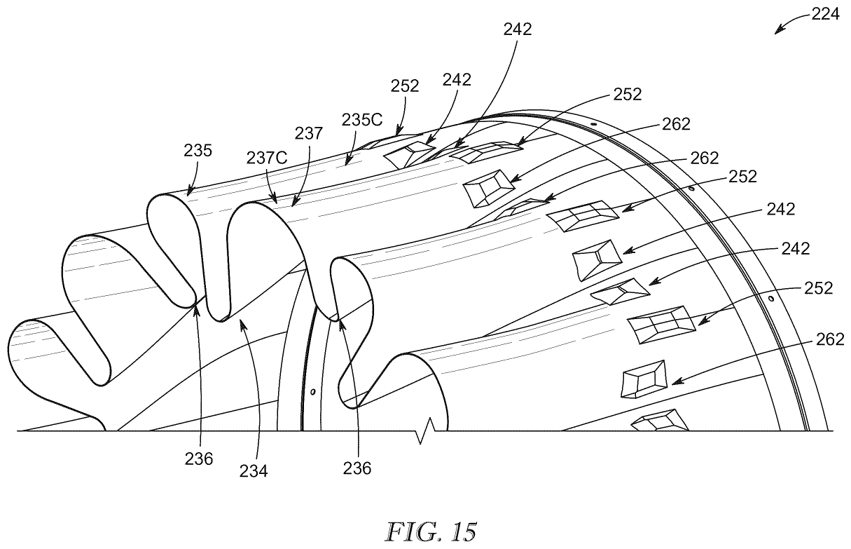

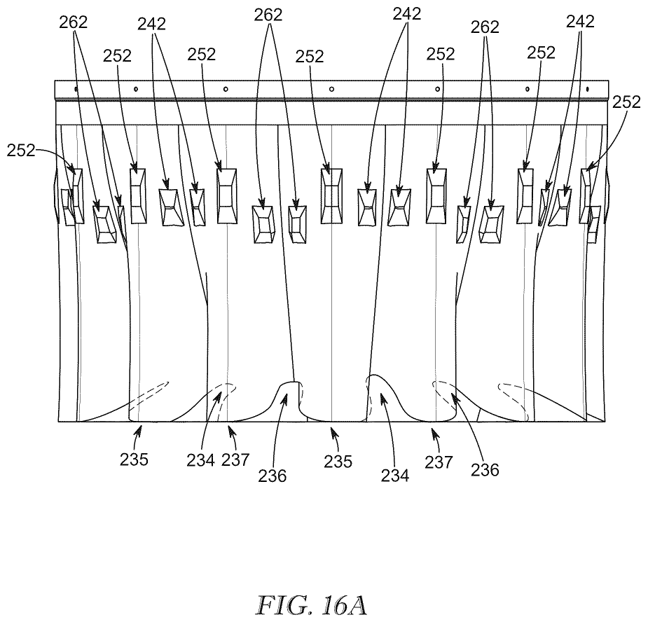

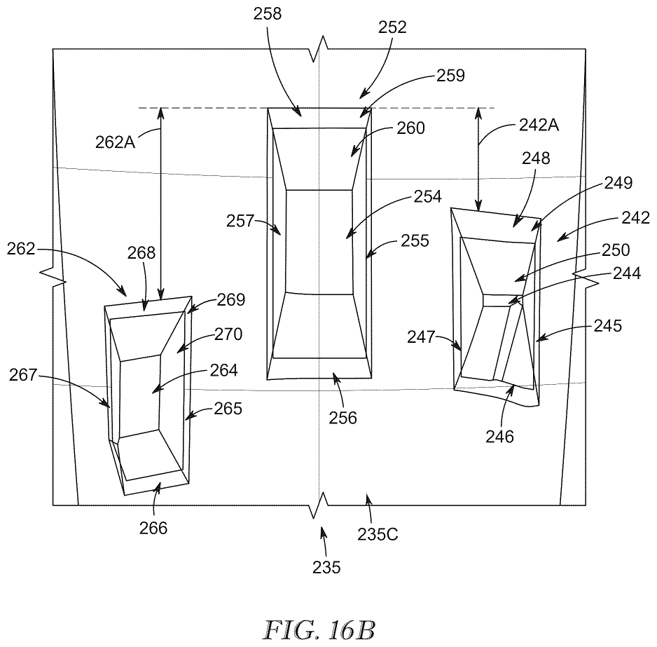

As can be seen in FIGS. 14-16A, the plurality of raised enclosures 242, 252, 262 are arranged in groups around the circumference of the exhaust mixer 224. Illustratively, each outer lobe 235, 237 includes three raised enclosures 242, 252, 262 with one raised enclosure 252 arranged centrally on the lobe 235, 237 and the other two raised enclosures 242, 262 arranged on opposing sides of the central raised enclosure 252. In some embodiments, each first outer lobe 235 includes a third raised enclosure 262, a second, central raised enclosure 252, and then a first raised enclosure 242, as viewed left-to-right (first circumferential direction) in FIG. 16A. Each second outer lobe 237 includes a first raised enclosure 242, a second, central raised enclosure 252, and then a third raised enclosure 262, as viewed left-to-right (first circumferential direction) in FIG. 16A. In some embodiments, the side enclosures (first and third raised enclosures 242, 262) may be arranged at a transition area at which the outer lobes 235, 237 begin to transition into the adjacent inner lobes 234, 236, as can be seen in FIGS. 15, 17, and 19. This specific configuration may lend itself to damping specific vibratory responses predicted by the methods described herein. The raised enclosures 242, 252, 262 may also be arranged just axially aft of a transition from the annular ring 226 to the lobes 235, 237. In other words, the raised enclosures 242, 252, 262 are arranged at an axially forward end of the lobes 235, 237, with the raised enclosure 252 being the most axially forward of the three raised enclosures 242, 252, 262.

As can be seen in greater detail in FIGS. 16B-19, the first raised enclosures 242 may be axially offset from a forward end of the second raised enclosures 252 in each group by a first axial distance 242A, and the third raised enclosures 262 may be axially offset from the forward end of the second raised enclosures 252 in each group by a second axial distance 262A greater than the first axial distance 242A. This may provide damping benefits for particular vibratory responses of the exhaust mixer 224. Each raised enclosure 242, 252, 262 may be formed to have the same general shape while having slightly differing volumes. In other embodiments, each enclosure 242, 252, 262 may be formed to have differing shapes and volumes based on the predicted vibratory responses of the exhaust mixer 224.

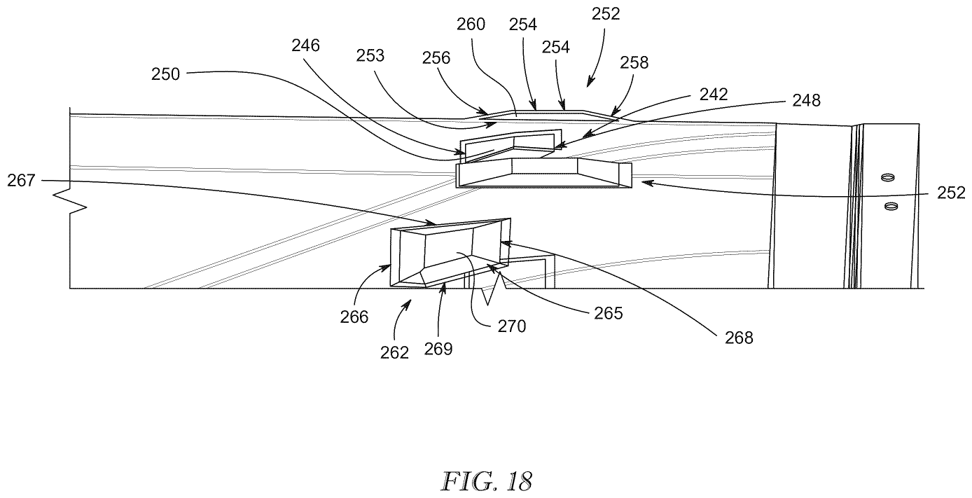

As can be seen in FIGS. 16B-19, each raised enclosure 242, 252, 262 may include a generally prismatic trapezoidal shape when viewed from the side (see FIGS. 18 and 19). Specifically, each enclosure 242, 252, 262 can include a radially outer top wall 244, 254, 264 spaced apart from a radially outer wall 243, 253, 263 of the outer lobe 235, 237. The radially outer top wall 244, 254, 264 is supported by a first side wall 245, 255, 265, a third side wall 247, 257, 267 opposite the first side wall 245, 255, 265, and second and fourth side walls 246, 256, 266, 248, 258, 268 opposite each other and extending between the ends of and interconnecting the first and second side walls 245, 255, 265, 247, 257, 267. Each raised enclosure 242, 252, 262 may thus include a damping cavity 249, 259, 269 defined by the side walls 245, 246, 247, 248, 255, 256, 257, 258, 265, 266, 267, 268, the radially outer top wall 244, 254, 264, and the radially outer wall 243, 253, 263 of the outer lobe 235, 237. A damping medium 250, 260, 270 is arranged within the cavity 249, 259, 269 so as to aid in damping or mistuning of a vibratory response occurring in the exhaust mixer 224 during operation of the engine 10.

As can be seen in FIG. 16B, the radially outer top wall 244, 254, 264 has a smaller surface area than the area defined within the perimeter defined by the lower (radially inward) sides of the side walls 245, 246, 247, 248, 255, 256, 257, 258, 265, 266, 267, 268 of the raised enclosures 242, 252, 262. Moreover, each side wall 245, 246, 247, 248, 255, 256, 257, 258, 265, 266, 267, 268 can include a trapezoidal shape so as to form the general prismatic trapezoidal shape of the raised enclosures 242, 252, 262.

Illustratively, the second raised enclosure 252 may be formed to be the largest of the three raised enclosures 242, 252, 262, the third raised enclosure 262 may be formed to be smaller than the second raised enclosure 252, and the first raised enclosure 242 may be formed to be the smallest of the three raised enclosures 242, 252, 262, as shown in FIGS. 16A, 16B, and 18. As a result, the second damping cavity 259 may be the largest of the three cavities 249, 259, 269, the third damping cavity 269 may be the second largest, and the first damping cavity 249 may be the smallest.

As described above, the damping or mistuning of the vibratory response can also occur due to bending deformation, in particular due to the damping cavities 249, 259, 269 defined within the enclosures 242, 252, 262 bending. As the cavities 249, 259, 269 change shape, the particles of the damping mediums 250, 260, 270 will move into vacant space through contact with other particles as well as the inner surfaces of the raised enclosures 242, 252, 262, thus creating a damping effect.

It is noted that, while this general configuration of the raised enclosures 242, 252, 262 and damping cavities 249, 259, 269 defined therein may provide damping effects for certain vibratory responses, the properties and locations of the raised enclosures 242, 252, 262, such as those related to the parameters discussed above, can be tailored based on specific predicted or known vibratory responses of the mixer 224 during operation of the engine 10 via additive layer manufacturing.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A gas turbine engine comprising
an engine core arranged about a central axis of the gas turbine engine and configured to combust a first portion of air entering the gas turbine engine and exhaust the combusted air aft of the engine core,
a fan assembly including an inlet fan forward of the engine core and a bypass duct located aft of the inlet fan and at least partially radially surrounding the engine core, wherein the inlet fan directs the first portion of air into the engine core and a second portion of air into the bypass duct, and
an exhaust mixer formed via additive layer manufacturing and arranged aft of the engine core and the bypass duct, the exhaust mixer being configured to mix the second portion of air exiting the bypass duct and the first portion of air exiting the engine core and subsequently exhaust the mixture of the first and second portions of air aft of the engine, the exhaust mixer including an annular wall extending about the central axis and having a plurality of inner lobes that each define a first channel therein that opens radially outwardly and a plurality of outer lobes that each define a second channel therein that opens radially inwardly,
wherein the exhaust mixer includes at least one damping cavity arranged on or at least partially within the annular wall on an inner lobe or an outer lobe of the plurality of inner and outer lobes, wherein the at least one damping cavity includes a damping medium arranged therein, and wherein the at least one damping cavity is configured to be selectively formed via the additive layer manufacturing so as to selectively effect at least one parameter of the at least one damping cavity based on a predicted vibratory response of the exhaust mixer that occurs during operation of the gas turbine engine such that movement of the damping medium within the at least one damping cavity damps vibrations of the exhaust mixer.

2. The gas turbine engine of claim 1, wherein the at least one parameter of the at least one damping cavity that is selectively effected via the additive layer manufacturing of the at least one damping cavity includes a location of the at least one damping cavity on the inner or outer lobe, a size and/or volume of the at least one damping cavity, an internal surface area of the at least one damping cavity, a density of the at least one damping cavity and/or the damping medium, a packing density of the damping medium, or a density and/or size of particles of the damping medium.

3. The gas turbine engine of claim 2, wherein the plurality of inner and outer lobes each extend toward and terminate at an aft end of the exhaust mixer, and wherein the annular wall alternates between inner and outer lobes about a circumferential extent of the exhaust mixer.

4. The gas turbine engine of claim 3, wherein the at least one damping cavity includes a plurality of damping cavities each formed within opposing side walls of each inner lobe of the plurality of inner lobes.

5. The gas turbine engine of claim 4, wherein the plurality of inner lobes alternate about the circumferential extent of the exhaust mixer between first inner lobes that have a radially inner end located a first distance from the central axis and second inner lobes that have a radially inner end located a second distance from the central axis, and wherein the second distance is greater than the first distance.

6. The gas turbine engine of claim 5, wherein the plurality of damping cavities include first damping cavities formed in the first inner lobes and second damping cavities formed in the second inner lobes, and wherein a volume of the first damping cavities is greater than a volume of the second damping cavities.

7. The gas turbine engine of claim 3, wherein the at least one damping cavity includes a plurality of damping cavities each formed within the second channel of the plurality of outer lobes.

8. The gas turbine engine of claim 7, wherein each damping cavity is formed in a radially outer side of the outer lobe, and wherein each damping cavity is defined by a radially outer wall of the outer lobe and a second wall extending between spaced apart locations on the radially outer wall, the second wall being spaced apart from the radially outer wall so as to define the damping cavity therebetween.

9. The gas turbine engine of claim 8, wherein the second wall includes a recessed portion that extends in an axial direction of the exhaust mixer.

10. The gas turbine engine of claim 3, wherein the at least one damping cavity is defined by at least one raised enclosure formed on a radially outer side of one of the plurality of outer lobes.

11. The gas turbine engine of claim 10, wherein the at least one raised enclosure includes a radially outer top wall spaced apart from a radially outer wall of the outer lobe so as to define the damping cavity therebetween.

12. The gas turbine engine of claim 11, wherein the at least one raised enclosure includes a plurality of raised enclosures each defining a damping cavity of the plurality of damping cavities therein, wherein a first group of the plurality of raised enclosures are arranged on the radially outer side of the plurality of outer lobes, and wherein a second group of the plurality of raised enclosures are arranged on the radially outer side of a transition between the plurality of outer lobes and an adjacent inner lobe.

13. An exhaust mixer for gas turbine engine, comprising
an annular wall that extends about a central axis of the gas turbine engine, the annular wall including a plurality of inner lobes that each define a first channel therein that opens radially outwardly and a plurality of outer lobes that each define a second channel therein that opens radially inwardly, and
at least one damping cavity arranged on or at least partially within the annular wall on an inner lobe or an outer lobe of the plurality of inner and outer lobes,
wherein the at least one damping cavity includes a damping medium arranged therein such that movement of the damping medium within the at least one damping cavity damps vibrations of the exhaust mixer.

14. The exhaust mixer of claim 13, wherein the at least one damping cavity is configured to be selectively formed via the additive layer manufacturing so as to selectively effect at least one parameter of the at least one damping cavity based on a predicted vibratory response of the exhaust mixer during operation of the gas turbine engine such that movement of the damping medium within the at least one damping cavity damps vibrations of the exhaust mixer.

15. The gas turbine engine of claim 14, wherein the at least one parameter of the at least one damping cavity that is selectively effected via the additive layer manufacturing of the at least one damping cavity includes a location of the at least one damping cavity on the inner or outer lobe relative to a forward end of the exhaust mixer, a size and/or volume of the at least one damping cavity, an internal surface area of the at least one damping cavity, a density of the at least one damping cavity and/or the damping medium, a packing density of the damping medium, or a density and/or size of particles of the damping medium.

16. The gas turbine engine of claim 15, wherein the plurality of inner and outer lobes each extend away from an aft end of the exhaust mixer, and wherein the annular wall alternates between inner and outer lobes about a circumferential extent of the exhaust mixer.

17. The gas turbine engine of claim 3, wherein the at least one damping cavity includes a plurality of damping cavities formed in at least one of within opposing side walls of each inner lobe of the plurality of inner lobes or within the second channel of the plurality of outer lobes.

18. A method comprising
arranging an engine core about a central axis of a gas turbine engine, the engine core configured to combust a first portion of air entering the gas turbine engine and exhaust the combusted air aft of the engine core,
providing a fan assembly including an inlet fan arranged forward of the engine core and a bypass duct located aft of the inlet fan and at least partially radially surrounding the engine core, wherein the inlet fan directs the first portion of air into the engine core and a second portion of air into the bypass duct, and
forming an exhaust mixer via additive layer manufacturing and arranging the exhaust mixer aft of the engine core and the bypass duct, the exhaust mixer configured to mix the second portion of air exiting the bypass duct and the first portion of air exiting the engine core and subsequently exhaust the mixture of the first and second portions of air aft of the engine,
wherein forming the exhaust mixer includes
forming an annular wall extending about the central axis, the annular wall having a plurality of inner lobes that each define a first channel therein that opens radially outwardly and a plurality of outer lobes that each define a second channel therein that opens radially inwardly, and
forming at least one damping cavity on or at least partially within the annular wall on an inner lobe or an outer lobe of the plurality of inner and outer lobes, wherein the at least one damping cavity is formed to include a damping medium arranged therein such that movement of the damping medium within the at least one damping cavity damps vibrations of the exhaust mixer.

19. The method of claim 18, further comprising
determining a predicted vibratory response of the exhaust mixer that occurs during operation of the gas turbine engine, and
selectively forming the at least one damping cavity in order to effect at least one parameter of the at least one damping cavity based on the predicted vibratory response of the exhaust mixer.

20. The method of claim 19, wherein the at least one parameter of the at least one damping cavity that is selectively effected via the additive layer manufacturing of the at least one damping cavity includes a location of the at least one damping cavity on the inner or outer lobe relative to a forward end of the exhaust mixer, a size and/or volume of the at least one damping cavity, an internal surface area of the at least one damping cavity, a density of the at least one damping cavity and/or the damping medium, a packing density of the damping medium, or a density and/or size of particles of the damping medium.
